(19) United States
(12) Patent Application Publication
(10) Pub. No.: US 2024/0045728 A1
(43) Pub. Date: Feb. 8, 2024

(54) METHOD FOR PROCESSING SENSOR DATA

(71) Applicant: Robert Bosch GmbH, Stuttgart (DE)

(72) Inventors: Andreas Heyl, Weil Der Stadt (DE); Dennis Grewe, Renningen (DE); Naresh Ganesh Nayak, Leonberg (DE); Paulius Duplys, Markgroeningen (DE)

(21) Appl. No.: 18/317,641

(22) Filed: May 15, 2023

(30) Foreign Application Priority Data
Aug. 3, 2022 (DE) 10 2022 208 088.2

(51) Int. Cl. G06F 9/50; G05B 19/4155

(52) U.S. Cl. CPC G06F 9/5066; G05B 19/4155; G05B 2219/50391

(57) ABSTRACT

A method for processing sensor data representing one or more objects. The method includes semantically segmenting the sensor data so that the sensor data are divided into sensor data portions so that, for each of the one or more objects, a respective sensor data portion contains that part of the sensor data that represents the object; ascertaining, for a processing task through which the sensor data are to be processed, a division of the processing task into subtasks comprising at least one subtask to be outsourced, wherein it is ensured that each subtask to be outsourced processes respective sub-data of the sensor data, which sub-data contain, for each sensor data portion, at most a part of the sensor data portion; and outsourcing the at least one subtask to be outsourced.

### CROSS REFERENCE

The present application claims the benefit under 35 U.S.C. § 119 of German Patent Application No. DE 10 2022 208 088.2 filed on Aug. 3, 2022, which is expressly incorporated herein by reference in its entirety.

### FIELD

The present disclosure relates to methods for processing sensor data.

### BACKGROUND INFORMATION

The software-implemented functionalities for operating robotic devices have reached a considerable extent for some applications, e.g., for controlling a vehicle. At the same time, the processing resources in such devices are typically constrained, while processing resources are typically available externally, for example, in an edge or a cloud.

However, outsourcing processing tasks from a robotic device to one or more external data processing facilities also means that the data that is to be processed externally is exposed to attacks.

Approaches for protecting data the processing of which is to be outsourced are therefore desirable.

### SUMMARY

According to various example embodiments of the present invention, a method for processing sensor data representing one or more objects is provided, comprising semantically segmenting the sensor data so that the sensor data are divided into sensor data portions so that, for each of the one or more objects, a respective sensor data portion contains that part of the sensor data that represents the object; ascertaining, for a processing task through which the sensor data are to be processed, a division of the processing task into subtasks comprising at least one subtask to be outsourced, wherein it is ensured that each subtask to be outsourced processes respective sub-data of the sensor data, which subtask contains, for each sensor data portion, at most a part of the sensor data portion; and outsourcing the at least one subtask to be outsourced.

The method described above enables the processing of data by several data processing facilities, wherein it is ensured that an attacker who gains access to the sub-data processed by a data processing facility only obtains partial information about the objects (i.e., does not obtain complete information about the object for any of the objects).

Various exemplary embodiments of the present invention are specified below.

Exemplary Embodiment 1 is a method for processing sensor data representing one or more objects, as described above.

An exemplary embodiment is a method according to Exemplary Embodiment 1, wherein the sensor data are acquired by a robotic device, the processing task is a processing task for controlling the robotic device, and the at least one subtask to be outsourced is outsourced to at least one data processing facility external to the robotic device.

Resources in the robotic device can thus be conserved by outsourcing processing tasks to external data processing facilities (in particular those that are not trustworthy or that are connected to the robotic device via non-secure communication links) so that only partial information about the objects is disclosed.

Exemplary Embodiment 3 is a method according to Exemplary Embodiment 1 or 2, wherein the sensor data are one or more images or one or more point clouds.

These sensor data can be efficiently segmented and divided such that each part contains only incomplete parts of objects (e.g., only one image detail showing an object only partially).

Exemplary Embodiment 4 is a method according to one of Exemplary Embodiments 1 to 3, wherein the processing task comprises processing the sensor data using matrix operations, and wherein each subtask to be outsourced comprises processing the respective sub-data using matrix operations.

Processing of sensor data using matrix operations (such as processing a convolutional layer of a convolutional neural network) can be effectively divided into subtasks (i.e., parallelized), wherein the condition that the sub-data processed by each subtask contain, for each object, at most a part of the information about the object, can be fulfilled (e.g., by appropriately selecting image details, such as blocks of rows, columns or diagonals).

Exemplary Embodiment 5 is a method according to one of Exemplary Embodiments 1 to 4, wherein the processing task is divided into several subtasks to be outsourced, wherein each subtask is outsourced to a respective data processing facility.

This reduces the risk of an attacker gaining access to several sets of sub-data (i.e., the sub-data to be processed by several subtasks) and thus increasing the information they can obtain about the objects.

Exemplary Embodiment 6 is a data processing device (e.g., a robot control device) configured to perform a method according to one of Exemplary Embodiments 1 to 5.

Exemplary Embodiment 7 is a computer program comprising instructions that, when executed by a processor, cause the processor to perform a method according to one of Exemplary Embodiments 1 to 5.

Exemplary Embodiment 8 is a computer-readable medium storing instructions that, when executed by a processor, cause the processor to perform a method according to one of Exemplary Embodiments 1 to 5.

In the figures, similar reference signs generally refer to the same parts throughout the various views. The figures are not necessarily to scale, wherein emphasis is instead generally placed on representing the principles of the present invention. In the following description, various aspects are described with reference to the figures.

### BRIEF DESCRIPTION OF THE DRAWINGS

FIG. 1 shows a vehicle, according to an example embodiment of the present invention.

FIG. 2 illustrates the distribution of a data processing task from a vehicle to several external data processing facilities, according to an example embodiment of the present invention.

FIG. 3 shows a flow chart, according to one example embodiment of the preset invention, depicting a method for processing sensor data representing one or more objects.

### DETAILED DESCRIPTION OF EXAMPLE EMBODIMENTS

The following detailed description relates to the figures, which show, for clarification, specific details and aspects of this disclosure in which the present invention may be implemented. Other aspects can be used, and structural, logical, and electrical changes can be made without departing from the scope of protection of the present invention. The various aspects of this disclosure are not necessarily mutually exclusive since some aspects of this disclosure can be combined with one or more other aspects of this disclosure in order to form new aspects.

Various examples are described in more detail below.

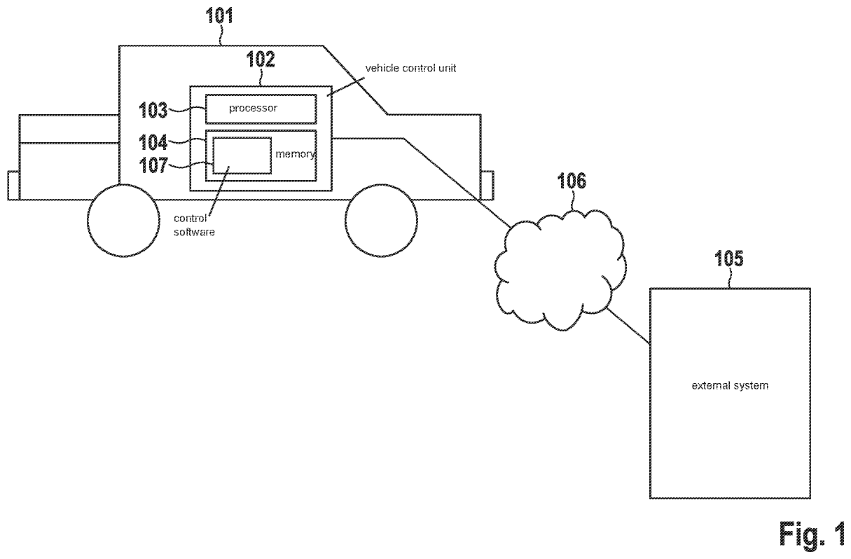

FIG. 1 shows a vehicle 101.

In the example of FIG. 1, a vehicle 101, e.g., a car or truck, is provided with a vehicle control unit (e.g., consisting of one or more electronic control units (ECUs)) 102.

The vehicle control unit 102 comprises data processing components, e.g., a processor (e.g., a CPU (central processing unit)) 103 and a memory 104 for storing control software 107 according to which the vehicle control unit 102 operates, and data that are processed by the processor 103. The vehicle control unit 102 may comprise several data processing devices (e.g., ECUs) connected to one another via an internal communication network (e.g., a CAN bus). These data processing devices may also execute the control software 107 in a distributed manner.

For example, the stored control software (computer program) comprises instructions that, when executed by the processor (or by several processors in a distributed manner), cause the processor 103 (or the processors) to carry out driver assistance functions (or also to collect trip data) or to even autonomously control the vehicle.

Future vehicle E/E architectures are expected to be highly networked with external data processing facilities, e.g., a cloud, edge, other vehicles, smart devices, etc., since, for example on the basis of 5G technology, the communication between the vehicle and the data processing facilities can take place with very low latency. This will provide the possibility of utilizing resources outside the vehicle during the driving operation, in order to perform calculations for in-vehicle functions, or of utilizing specific hardware/software components for specific use cases, e.g., hardware accelerators, such as GPUs or FPGAs, in an edge or a cloud. One example application is the continuous diagnosis of driving algorithms for the purpose of error or anomaly detection. The specialized and more resource-intensive HW/SW components in the edge or cloud can be drawn upon to quickly detect malfunctions of the algorithms.

For example, the vehicle 101 can be networked (practically permanently, or for at least large time periods of its operation) to an external system 105, such as one or more servers of a cloud or an edge computing platform (here via a communication network 106), and communication between the vehicle 101 (generally, a robotic device, in particular a mobile robotic device) and the external system 105 can be provided with low latency (e.g., by means of 5G).

However, this requires that parts of the data or applications are transmitted to the edge or cloud infrastructure at runtime. Transferring data for such use cases between the vehicle and the computing unit (in the edge or cloud) via an open, untrustworthy communication network 106 presents a challenge to data communication security (data security and data protection) and to ensuring the protection of intellectual property.

For example, the following groups of in particular personal data, applications and intellectual property should be protected, i.e., kept as secret as possible:
perception:
   raw sensor signals or pre-processed sensor data, from which conclusions could be drawn about the sensor technology or the sensor signal (pre-)processing
   sensor pre-processing functions
planning:
   format and content of the environmental model, e.g., object classes and their attributed properties
   predictive models (e.g., as a library)
   functions for calculating behavior
   cost functions for behavior assessment
   functions for calculating trajectories
   cost functions for trajectory assessment
route planning
   algorithms for calculating the optimal route
E/E (electric/electronic) architecture
   sensor signals for sensor diagnosis
   algorithms for predictive health management
   configuration of the powertrain or of the vehicle
   (current) properties of the powertrain or of the vehicle system

Approaches for maintaining data security and data protection when exchanging and processing data between two parties, such as the following, cannot be used for these use cases or can only be used for these use cases with disadvantages (e.g., higher latency):
differential privacy: maximizing the accuracy of responses to queries to databases while minimizing the likelihood of being able to identify the data sets used for responding
secure enclave: a subsystem that is isolated from the respective master processor, provides an additional security level and is designed to ensure the security of sensitive user data even if the core of the master processor is compromised
obfuscation: intentional alteration of program code so that source code becomes hard to understand for humans or hard to recover.

According to various embodiments of the present invention, mechanisms are provided to ensure the protection of intellectual property and data protection by outsourcing parts of data and applications in a distributed data processing system (e.g., a reliable distributed system) in the context of a controller of a robotic device, such as highly automated driving (e.g., for continuous diagnosis of driving algorithms). In particular, the distributed data processing system may comprise data processing facilities of an edge or cloud. These are mechanisms that enable, for example in the vehicle controller, data protection during short-term outsourcing of data and applications to a greater amount of computing nodes along the travel route, in order to thus make compromise (at least through a single attack) more difficult.

According to various embodiments of the present invention, instead of having complete calculations performed by a single external data processing facility, e.g., so that extensive calculations are outsourced to a single GPU cluster (such as a server 105) or entire applications are outsourced to an edge or cloud infrastructure, and all the data to be processed are thus transmitted together, the calculation is divided into sub-calculations according to a specific secure multi-party computing method (e.g., Shamir's Secret Sharing, SPDZ1 or another method such as Carbyne Stack), which sub-calculations are subsequently distributed to external resources (or services), wherein the (sub-)data transmitted for the different sub-calculations are transmitted separately. The division into sub-calculations is carried out such that only minor conclusions (i.e., at least no complete conclusion) can be drawn about intellectual property or personal data from the individual sub-calculations or the (sub-)data transmitted for this purpose.

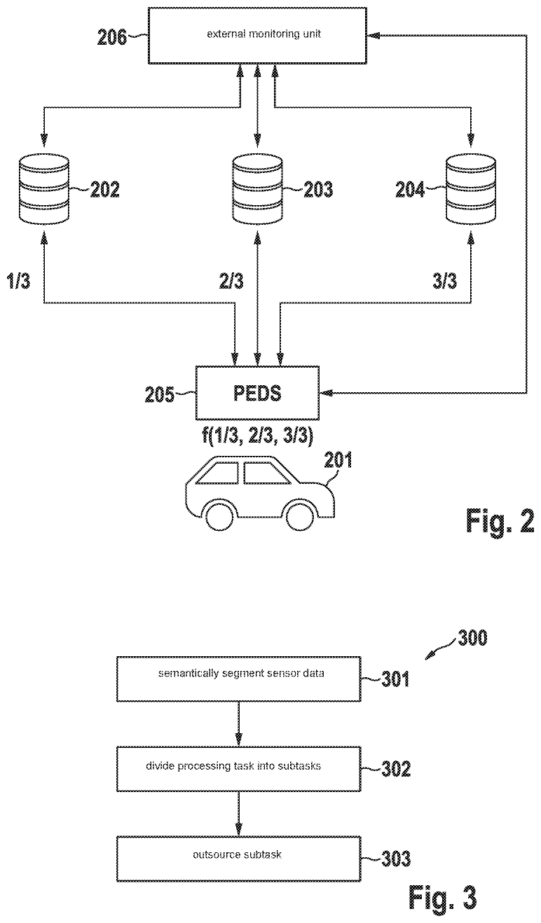

FIG. 2 illustrates the distribution of a data processing task from a vehicle 201 to several external data processing facilities 202, 203, 204 (e.g., in one or more clouds and/or edges).

The vehicle 201 (e.g., the control unit 102) implements a task distribution service 205 (referred to as a PEDS (privacy-ensuring distribution service) in one embodiment). This service receives a specification for an (in-vehicle) data processing task, e.g., a computing job from a program (or another in-vehicle function) executed on the control unit 102, for example with transfer parameters, which indicates the nature of the calculation as well as division and merge options.

The task distribution service 205 divides the data processing task into sub-calculations, e.g., calculations performed in parallel. This may take place, to some extent, randomly or systematically as long as each sub-calculation processes a part of the (total) data to be processed by the data processing task, which part only allows a limited conclusion about the total data. An exception can be the sub-calculations that are carried out in the vehicle, i.e., at least every sub-calculation to be distributed externally must only process a part of the (total) data, which only allow a limited conclusion about the total data.

The task distribution service 205 can then ascertain several alternatives for distributing the sub-calculations to internal vehicle devices 202 and external devices 202, 203, 204, such as cloud and various edge nodes or various software nodes, check the alternatives (e.g., in terms of security, data protection, and service quality (e.g., maximum latency), and select one of them. In doing so, the service takes into account which sub-calculations may be outsourced (in particular only those that process only a part of the (total) data, which only allow a limited conclusion about the total data).

The distribution may also be supported by an external monitoring unit 206 (external to the vehicle) that knows current states of the considered data processing facility 202, 203, 204, e.g., a current compromise, current latency, current load, and mutual dependencies.

After selecting a distribution, the task distribution service 205 requests (e.g., through corresponding service calls) the respective subtasks to be performed by the data processing facilities 202, 203, 204 involved in the distribution. For this purpose, the task distribution service 205 sends, to each data processing facility 202, 203, 204 that is to perform one of the subtasks, the sub-data (of the total data) to be processed by the respective subtask and collects, after the performance of the subtasks by the respective external data processing facilities 202, 203, 204 and, where applicable, also internal data processing facilities 202 (e.g., ECUs), the partial results, merges them into an overall result and delivers the result to the entity (e.g., program) from which the computing job came.

The task distribution service 205 may also re-request the performance of a subtask, for example because the service that was to perform the subtask has failed.

The communication of the task distribution service 205 with the external data processing facilities 202, 203, 204 (sending the requests to perform subtasks and receiving the results) takes place, for example, via one or more modules for external communication. In so doing, the task distribution service 205 may select various communication channels for communication, e.g., IEEE 802.11p, V2X, 5G.

The functionality of the task distribution service 205 may also be provided, at least in part, externally to the vehicle. For example, ascertaining possible divisions into subtasks and the distribution thereof and the merging of the sub-calculations can be performed in a secured edge, e.g., a secured execution environment (trusted execution environment, e.g., with SGX implemented).

For example, the partial results may be passed between the data processing facilities 202, 203, 204, e.g., edge nodes, for example along a route of edge servers.

The task distribution service 205 may additionally request information about the properties of the available data processing facilities 202, 203, 204, e.g., by direct query to the data processing facilities 202, 203, 204 or query to the monitoring unit (or also a ledger of a DLT (distributed ledger technology)), where this information is collected and stored.

Mechanisms may be provided to avoid that distributed sub-calculations are not merged (randomly or in a manner controlled by an attacker) on a node after all. For example, a central function (e.g., a manager function in the monitoring unit) is provided that ensures that no data processing system 202, 203, 204 (e.g., no edge node) is selected for two sub-calculations (e.g., through forwarding). The central function can also dynamically configure the distribution, taking into account the current states of the nodes (security, load, latency). By assigning a (unique) identification to the original data processing task to which the sub-calculations belong, a data processing system 202, 203, 204 that is already performing a sub-calculation of the data processing task can determine that a further sub-calculation requested from it belongs to the data processing task, and can reject it.

The partitioning is particularly suitable for a data processing task such as a highly parallelizable matrix operation, which is the basis, for example, for the implementation of a neural network or a sequential Monte Carlo method (also referred to as a particle filter). For example, in convolutional neural networks (CNN), only parts of an image are sequentially evaluated at all times and this sub-calculation (application of the filter core to a part of the image) does not allow any conclusion or only a limited conclusion about the overall image.

Generally, the data to be processed by the one data processing task, i.e., the input data of the data processing task, are, for example, sensor data (or also model data), and the data processing task is divided into subtasks in such a way that the division comprises at least one subtask, which processes those sub-data of the input data of the data processing task that do not allow any conclusion about the input data, at least to some extent, for example no conclusion about the semantic meaning the sub-data have.

According to various embodiments, this is achieved by the sub-data containing only a part of the sensor data representing a respective object. For example, the sensor data are an image (or, more generally, a point cloud) so that each pixel (or point of the point cloud) belongs to an object, i.e., shows or represents it.

The task is then divided into subtasks in such a way that each subtask includes only a part of the sensor data representing an object, so that, for each subtask (or at least for each subtask to be distributed externally), the complete information, contained in the sensor data, about the object cannot be reconstructed, for any of the objects, from the sub-data that are processed by the subtask (and that must, correspondingly, be sent to the data processing facilities that processes the subtask).

For example, in the case of an image (and similarly in the case of a point cloud), an object detection is performed, the image is divided into regions (i.e., generally sensor data portions), wherein each region shows an object (and, e.g., a further region for the rest, i.e., the background), and the division into subtasks takes place in such a way that each subtask to be distributed externally contains only a part of each image region.

For example, if the data processing task is a convolution operation (as in a convolutional network), each subtask may be the application of a convolution filter to a respective sub-portion of the image, wherein the sub-portions are selected such that each of them shows each object at most partially (e.g., at most half).

The procedure can, for example, be similar in motion estimation, i.e., each subtask is the motion estimation for a sub-portion of the image (or of the point cloud) or for a sub-region of a dynamic grid map. When the partial results are merged, the task distribution service 205 can then, for example, average the motion estimation results associated with the same object.

In this way, according to various embodiments, data processing can be performed by involving several independent, processing data processing facilities 202 (operated or provided, for example, by different organizations, in particular with standard hardware), wherein data protection is ensured.

The monitoring unit 206 can control the division of the data to be processed and the distribution of the sub-data as a function of the reliability as well as the trustworthiness of the available data processing facilities, optionally also as a function of the criticality of the data themselves. For example, many computing nodes have so-called trusted platform modules (TPMs), which can be used to ensure the integrity (from a security point of view) of the software executed on the computing node. The monitoring unit 206 can query such TPMs and select, for the distribution of the sub-data, only those edge and cloud nodes that are also demonstrably (with the help of the TPM) unmanipulated, and control the distribution service 205 with corresponding inputs, i.e., supply it, for example, with the corresponding information so that it carries out a corresponding distribution.

In summary, according to various embodiments, a method as shown in FIG. 3 is provided.

FIG. 3 shows a flow chart 300, according to one embodiment, depicting a method for processing sensor data representing one or more objects.

In 301, the sensor data are semantically segmented so that the sensor data are divided into sensor data portions so that, for each of the one or more objects, a respective sensor data portion contains that part of the sensor data that represents the object.

In 302, for a processing task through which the sensor data are to be processed, a division of the processing task into subtasks that have at least one subtask to be outsourced is ascertained. In doing so, it is ensured that each subtask to be outsourced processes respective sub-data of the sensor data, which sub-data contain, for each sensor data portion, at most a part (e.g., at most 30%, at most 40%, at most 50%, or at most 60%) of the sensor data portion.

In 303, the at least one subtask to be outsourced is outsourced.

Each subtask is outsourced to a respective data processing facility (i.e., each subtask is outsourced to a separate data processing facility). A data processing facility may correspond to a data processing device (e.g., a server computer). In one embodiment, a data processing facility may however also comprise several data processing devices.

Ensuring that each subtask to be outsourced processes respective sub-data of the sensor data, which sub-data contain, for each sensor data portion, at most a part of the sensor data portion, comprises, for example, checking a corresponding criterion, and the subtasks to be outsourced are only outsourced if the criterion is fulfilled.

The method of FIG. 3 (and also the performance of the subtasks) can be performed by one or more data processing devices (e.g., computers) having one or more data processing units. The term “data processing unit” may be understood to mean any type of entity that enables the processing of data or signals. For example, the data or signals can be processed according to at least one (i.e., one or more than one) specific function performed by the data processing unit. A data processing unit may comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate assembly (FPGA), or any combination thereof. Any other way of implementing the respective functions described in more detail herein may also be understood as a data processing unit or logic circuitry. One or more of the method steps described in detail herein may be performed (e.g., implemented) by a data processing unit by one or more specific functions executed by the data processing unit.

The processing of sensor data serves, for example, to generate a control signal for a robotic device. The term “robotic device” may be understood as relating to any technical system (with a mechanical part whose movement is controlled), such as a computer-controlled machine, a vehicle, a household appliance, an electric tool, a manufacturing machine, a personal assistant, or an access control system. A control rule for the technical system is learned, and the technical system is then controlled accordingly.

Various embodiments may receive and use sensor signals from various sensors (e.g., of the respective robotic device), such as video, radar, LiDAR, ultrasound, movement, thermal imaging, etc., for example in order to obtain sensor data with regard to states of the system (robot and object or objects) and configurations and scenarios. The sensor data can be processed, e.g., by classifying the sensor data or performing a semantic segmentation, in order to detect the presence of objects (in the environment in which the sensor data were obtained).

Although specific embodiments have been illustrated and described herein, a person skilled in the art recognizes that the specific embodiments shown and described may be substituted for a variety of alternative and/or equivalent implementations without departing from the scope of protection of the present invention. This application is to cover any adaptations or variations of the specific embodiments discussed herein.

What is claimed is:

1. A method for processing sensor data representing one or more objects, comprising the following steps:
semantically segmenting the sensor data so that the sensor data are divided into sensor data portions so that, for each of the one or more objects, a respective sensor data portion contains that part of the sensor data that represents the object;
ascertaining, for a processing task through which the sensor data are to be processed, a division of the processing task into subtasks including at least one subtask to be outsourced, wherein it is ensured that each subtask to be outsourced processes respective sub-data of the sensor data, which sub-data contain, for each sensor data portion, at most a part of the sensor data portion; and
outsourcing the at least one subtask to be outsourced.

2. The method according to claim 1, wherein the sensor data are acquired by a robotic device, the processing task is a processing task for controlling the robotic device, and the at least one subtask to be outsourced is outsourced to at least one data processing device external to the robotic device.

3. The method according to claim 1, wherein the sensor data are: i) one or more images, or ii)one or more point clouds.

4. The method according to claim 1, wherein the processing task includes processing the sensor data using matrix operations, and wherein each subtask to be outsourced includes processing the respective sub-data using matrix operations.

5. The method according to claim 1, wherein the processing task is divided into multiple subtasks to be outsourced, wherein each subtask is outsourced to a respective data processing facility.

6. A data processing device configured to process sensor data representing one or more objects, the data processing device configured to:
semantically segment the sensor data so that the sensor data are divided into sensor data portions so that, for each of the one or more objects, a respective sensor data portion contains that part of the sensor data that represents the object;
ascertain, for a processing task through which the sensor data are to be processed, a division of the processing task into subtasks including at least one subtask to be outsourced, wherein it is ensured that each subtask to be outsourced processes respective sub-data of the sensor data, which sub-data contain, for each sensor data portion, at most a part of the sensor data portion; and
outsource the at least one subtask to be outsourced.

7. A non-transitory computer-readable medium on which are stored instructions for processing sensor data representing one or more objects, the instructions when executed by a processor, causing the processor to perform the following steps:
semantically segmenting the sensor data so that the sensor data are divided into sensor data portions so that, for each of the one or more objects, a respective sensor data portion contains that part of the sensor data that represents the object;
ascertaining, for a processing task through which the sensor data are to be processed, a division of the processing task into subtasks including at least one subtask to be outsourced, wherein it is ensured that each subtask to be outsourced processes respective sub-data of the sensor data, which sub-data contain, for each sensor data portion, at most a part of the sensor data portion; and
outsourcing the at least one subtask to be outsourced.
